(19) United States
(12) Patent Application Publication
(10) Pub. No.: US 2009/0239091 A1
(43) Pub. Date: Sep. 24, 2009

(54) METHOD FOR PRINTING A METAL PASTE, METAL MASK, AND BUMP FORMING METHOD

(75) Inventor: Masaaki Abe, Kumamoto (JP)

Correspondence Address: YOUNG & THOMPSON, 209 Madison Street, Suite 500, ALEXANDRIA, VA, 22314, US

(73) Assignee: NEC ELECTRONICS CORPORATION, Kanagawa (JP)

(21) Appl. No.: 12/394,595

(22) Filed: Feb. 27, 2009

(30) Foreign Application Priority Data
Mar. 18, 2008 (JP) 2008-069324

(51) Int. Cl. B32B 15/02; B05D 5/12

(52) U.S. Cl. 428/546; 427/123

(57) ABSTRACT

A method for printing a metal paste includes the step of arranging, to locate a through hole of a metal mask having the through hole on an electrode, a metal mask on a substrate and forming a gap portion communicating with the through hole in an interface between the substrate and the metal mask. According to this method, in filling of a metal paste, a flux oozing on a surface of the metal paste can be moved to the gap portion. In other words, a deaeration path for residual air in the metal paste clogged by the flux can be secured by removing the flux. In this manner, in the through hole, the remaining air in the metal paste can be removed, and a filling rate of the metal paste can be increased.

This application is based on Japanese patent application NO. 2008069324, the content of which is incorporated hereinto by reference.

### BACKGROUND

1. Technical Field

The present invention relates to a method for printing a metal paste, a metal mask, and a bump forming method.

2. Related Art

It is known that as electrode terminal formation in a flip chip BGA, a chip-size package, or the like, bump formation by a metal paste printing method using a metal mask is performed. The bump formation by the metal paste printing method uses a metal mask having a hole at a position corresponding to an electrode terminal formation position to fill the hole with a metal paste. More specifically, in order to fill the hole with the metal paste, a metal powder and a flux need to be mixed with each other to form a paste.

FIGS. 7A and 7B shows a metal mask on a semiconductor wafer used when bump formation is performed by a metal paste printing method on a semiconductor wafer having a flat surface to be printed.

Japanese Laid-open patent publication NO. 2000-062136 describes that, as shown in FIGS. 8A to 8E, when a solder paste is filled on an electrode formed on a bottom of a recessed portion, an opening size of a metal mask is made smaller than an opening size of the recessed portion to secure an interval between the metal mask and the substrate. It is described that in this manner air generated in filling of the solder paste is pushed out of the recessed portion from a gap near an edge of the recessed portion.

Techniques related to this include those described in Japanese Laid-open patent publication NO. 2002-118347, Japanese Laid-open patent publication NO. 2002-353263, Japanese Laid-open patent publication NO. 2006-148146, and Japanese Laid-open patent publication NO. 1999-040938.

### SUMMARY

However, in the method described by using FIGS. 7A to 8E, a pressure or the like generated in filling of a solder paste causes a flux to ooze from the inside of the filled solder paste, and the flux covers the solder paste. In FIGS. 7A and 7B, since a surface to be printed is flat, a wafer upper surface and a metal mask lower surface are easily brought into tight contact with each other. For this reason, the flux remains in a through hole while the flux covers the surface of the solder paste. Therefore, in the method described with reference to FIGS. 7A to 8E, when residual air is present in the filled solder paste, a deaeration path for the residual air is clogged with the flux, and the solder paste is incompletely filled disadvantageously.

In one embodiment, there is provided a method for printing a metal paste including: preparing a substrate having a surface on which an electrode is formed; arranging, to locate a through hole of a metal mask having the through hole on the electrode, the metal mask on the substrate and forming a gap portion communicating with the through hole in an interface between the substrate and the metal mask; and filling a metal paste containing a flux in the through hole, wherein the gap portion is formed by an upper surface of the substrate and a recessed portion formed in a lower surface of the metal mask, and, in the filling a metal paste, the flux is guided to the gap portion together with air in the through hole.

In another embodiment, there is provided a bump forming method using a method for printing a metal paste including: preparing a substrate having a surface on which an electrode is formed; arranging, to locate a through hole of a metal mask having the through hole on the electrode, the metal mask on the substrate and forming a gap portion communicating with the through hole in an interface between the substrate and the metal mask; and filling a metal paste containing a flux in the through hole, wherein the gap portion is formed by an upper surface of the substrate and a recessed portion formed in a lower surface of the metal mask, and, in the filling a metal paste, the flux is guided to the gap portion together with air in the through hole.

The method for printing a metal paste includes arranging, to locate a through hole of a metal mask having the through hole on the electrode, the metal mask on the substrate and forming a gap portion communicating with the through hole in an interface between the substrate and the metal mask, in the filling the metal paste, the flux is guided to the gap portion together with air in the through hole. According to this method, flux oozing on the surface of the metal paste can be moved to the gap portion in filling of the metal paste. In other words, a deaeration path for residual air in the metal paste clogged with the flux is secured by removing the flux. In this manner, air remaining in the metal paste in the through hole can be removed, and a filling rate of the metal paste can be increased.

In another embodiment, there is provided a metal mask used in a metal paste printing method which fills a metal paste containing a flux in a through hole of a metal mask arranged on an object to be printed to perform printing, wherein at least one surface of the metal mask has a recessed portion which forms a gap portion communicating with the through hole in an interface between the metal mask and the object to be printed, and the gap portion is configured to guide the flux together with air in the through hole.

In the metal mask, at least one of the surfaces of the metal mask has the recessed portion which forms the gap portion communicating with the through hole on the interface between the metal mask and the object to be printed, and the gap portion is configured to guide the flux together with the air in the through hole. According to the metal mask having the structure, in filling of the metal paste, the flux oozing on the surface of the metal paste can be moved to the gap portion. In other words, a deaeration path for residual air in the metal paste clogged with the flux is secured by removing the flux. In this manner, air remaining in the metal paste in the through hole can be removed, and a filling rate of the metal paste can be increased.

According to the present invention, a method for printing a metal paste and a metal mask which are better suited for improving a filling rate of a meal.

### BRIEF DESCRIPTION OF THE DRAWINGS

The above and other objects, advantages and features of the present invention will be more apparent from the following description of certain preferred embodiments taken in conjunction with the accompanying drawings, in which:

FIGS. 1A and 1B are a cross-sectional view and a plan view showing a first embodiment of a metal mask according to the present invention;

FIGS. 2A and 2B are a cross-sectional view and a plan view for explaining a metal mask and a solder paste printing method according to the present embodiment;

FIGS. 3A and 3B are a cross-sectional view and a plan view for explaining a metal mask and a solder paste printing method according to the present embodiment;

FIGS. 4A and 4B are a cross-sectional view and a plan view for explaining a metal mask and a solder paste printing method according to the present embodiment;

FIGS. 5A and 5B are a cross-sectional view and a plan view showing a second embodiment of a metal mask according to the present invention;

FIGS. 6A and 6B are a cross-sectional view and a plan view showing a third embodiment of a metal mask according to the present invention;

FIGS. 7A and 7B are a sectional view and a plan view showing a conventional metal mask; and

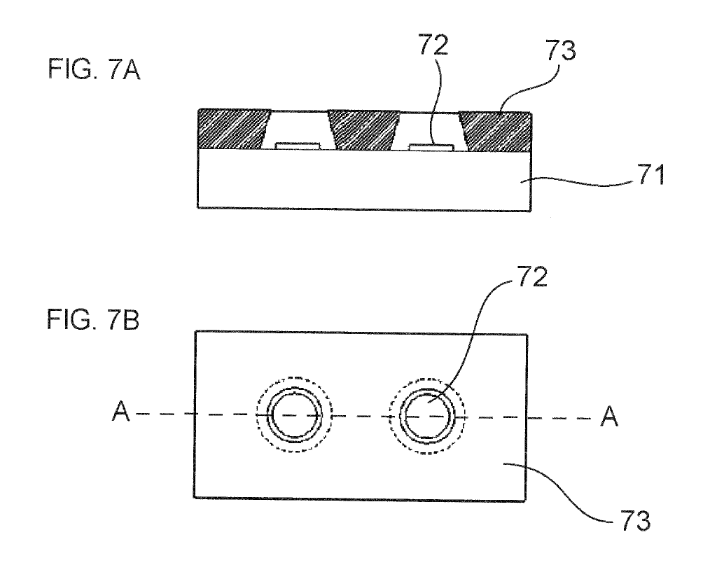

FIGS. 8A to 8E are cross-sectional views for explaining a conventional metal mask and steps in a conventional metal paste printing method.

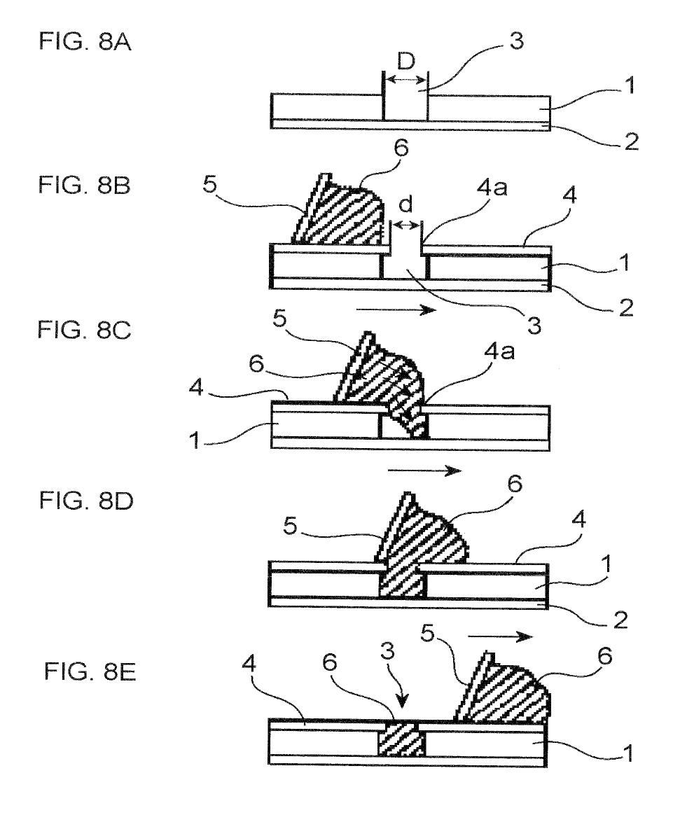

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposes.

Preferred embodiments of a method for printing a metal paste, a bump forming method, and a metal mask according to the present invention will be described below with reference to the accompanying drawings. The same reference numerals as in the description of the drawings denote the same parts in the description, and the description will not be repeated.

### First Embodiment

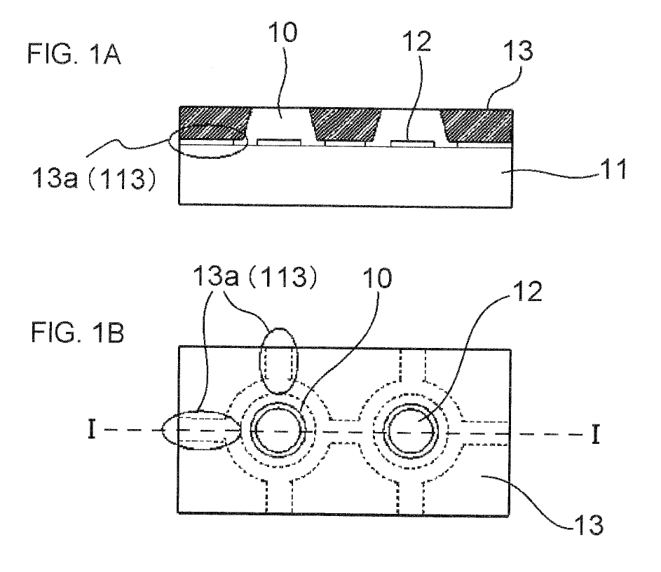

FIGS. 1A and 1B are a cross-sectional view and a plan view showing a first embodiment of a metal mask according to the present invention. The cross-sectional view shown in FIG. 1A shows a section along an I-I line shown in the plan view in FIG. 1B.

A metal mask 13 has, on at least one surface of the metal mask 13, a recessed portion 113 which forms a gap portion 13a communicating with a through hole 10 between the metal mask 13 and a substrate 11. The gap portion 13a is configured to guide a flux together with air in the through hole 10.

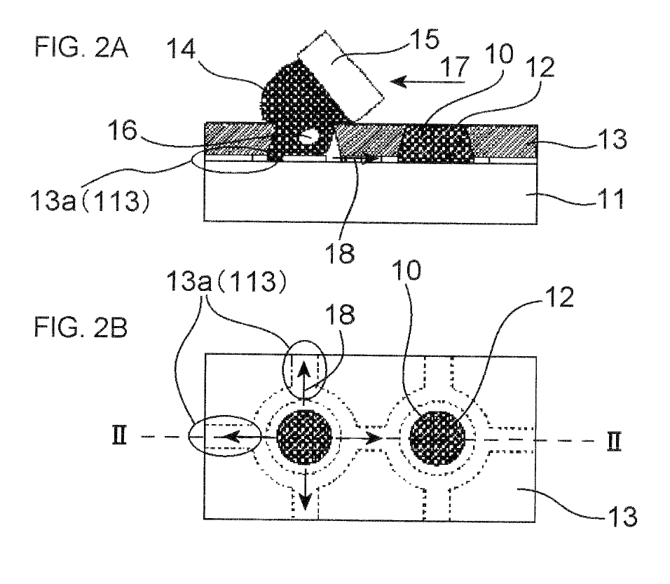

As shown in FIGS. 2A and 2B, the metal mask 13 is used in a method for printing a metal paste which fills a solder paste 14 containing a flux in the through hole 10 of the metal mask 13 arranged on the substrate 11.

The substrate 11 is an object to be printed and has an upper surface which is a surface to be printed. An electrode 12 is formed on the substrate 11.

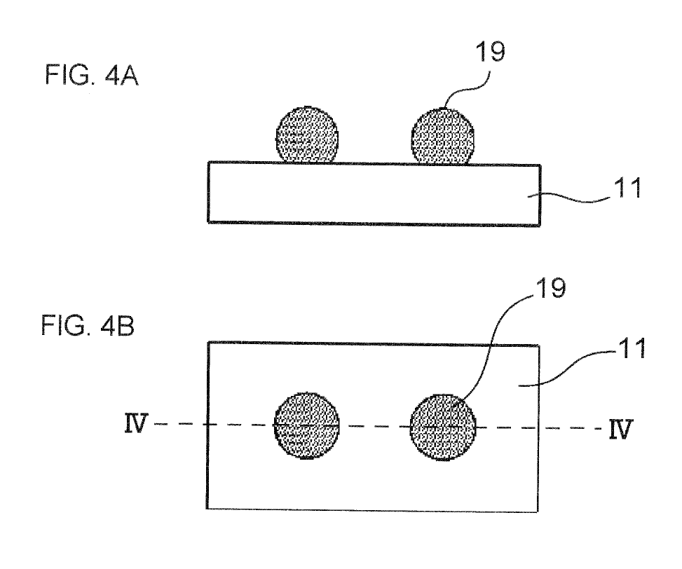

The through hole 10 is an opening reaching from an upper surface (printing surface) of the metal mask 13 to a lower surface (surface of the object to be printed) of the metal mask 13. The solder paste 14 is filled in the through hole 10. The through hole 10 may have a tapered shape in a cross-sectional view. In this manner, the solder paste 14 is printed on the electrode 12. Thereafter, a bump 19 shown in FIGS. 4A and 4B can be formed.

As shown in FIG. 1A, the gap portion 13a is configured to guide a flux together with air in the through hole 10. More specifically, the gap portion 13a is formed in an interface between the substrate 11 and the lower surface of the metal mask 13. More specifically, the gap portion 13a is formed by the upper surface of the substrate 11 and a recessed portion 133 formed on the lower surface of the metal mask 13, and a gap is secured in the interface between the upper surface of the substrate 11 and the recessed portion 133. In other words, the gap portion 13a can be secured in the interface between the substrate 11 and the metal mask 13 by the recessed portion 133 of the metal mask 13. Furthermore, two through holes 10 communicate with each other through the gap portion 13a. In other words, the recessed portion 113 (step) communicating with the through hole 10 is formed in a lower surface (surface of the object to be printed) of the metal mask 13. When the solder paste 14 is filled from an upper surface of the metal mask 13, a flux oozing from the solder paste 14 due to its weight or pressure can be moved to the gap portion 13a. Residual air 16 (see FIG. 4A) remaining in the solder paste 14 can also be moved to the gap portion 13a.

The height of the gap portion 13a is preferably smaller than the diameter of a solder particle included in the solder paste 14. In this manner, at least one of the air in the flux of the filled solder paste 14 and the air in the through hole 10 is removed to make it possible to increase a filling rate. Since the number of filled solder particles is stable, accuracy of the outside dimension of the bump 19 formed thereafter can be improved (see FIGS. 4A and 4B).

The diameter of the solder particle can be set to various values depending on sizes and pitches of the electrodes 12 on the object to be printed. For example, when a pad pitch of inner bumps on a flip chip is about 200 μm, the diameter of the solder particle can be set to 5 to 15 μm. When the pitch is relatively large, the diameter can be set to 15 to 25 μm.

A soldering material is not limited to a specific material. However, for example, a Pb-free solder, an eutectic solder, a high-temperature solder, or the like can be used. As the Pb-free solder, an SnAgCu-based alloy can be used. As the eutectic alloy or the high-temperature solder, a PbSn-based solder having variable Pb/Sn ratios can be used.

In the present embodiment, the SnAgCu-based solder was used, and the diameter of a solder particle was set to 5 to 15 μm.

As shown in FIG. 1B, on a lower surface of the metal mask 13, the through hole 10 is formed, and the recessed portion 113 (step) is formed throughout the circumference of the opening of the through hole 10. Furthermore, the recessed portion 113 radially extending from the circumference of the opening of the through hole 10 is formed to cause the through holes 10 to communicate with each other. By the recessed portion 113, the gap portion 13a is formed in an interface between the substrate 11 and the metal mask 13. More specifically, the gap portion 13a is formed to cause the plurality of through holes 10 to communicate with each other.

In this manner, a large-volume interval can be secured in an interface between the substrate 11 and the surface to be printed of the metal mask 13.

The solder paste 14 contains a flux and solder particles. The flux makes it possible to print and fill the solder paste 14. The type of the flux is not limited. The flux oozes from the inside of the solder paste 14 onto the surface of the solder paste 14 in printing or filling of the solder paste 14 due to the pressure of the printing or the filling to cover the surface of the filled solder paste 14. In this manner, a deaeration path of air remaining in the solder paste 14 is clogged.

A method for printing a metal paste which forms the bump 19 on an upper surface of the electrode 12 on the substrate 11 will be described below with reference to FIGS. 1A to 4B are cross-sectional views and plan views for explaining a metal mask and a solder paste printing method according to the present embodiment. The cross-sectional views in FIGS. 2A, 3A and 4A show sections along a II-II line to a IV-IV line shown in the plan views in FIGS. 2B, 3B and 4B.

The solder paste printing method according to the present embodiment includes: the step of preparing the substrate 11 having a surface on which the electrode 12 is formed; the step of arranging, to locate the through hole 10 of the metal mask 13 having the through hole 10 on the electrode 12, the metal mask 13 on the substrate 11 and forming the gap portion 13a communicating with the through hole 10 in an interface between the substrate 11 and the metal mask 13; and the step of filling the solder paste 14 containing a flux in the through hole 10. The gap portion 13a is formed by the upper surface of the substrate 11 and the recessed portion 133 formed in the lower surface of the metal mask 13. In the step of filling the solder paste 14, the flux is guided to the gap portion 13a together with air in the through hole 10.

The air in the through hole 10 includes air in the through hole 10 generated by the filled solder paste 14 and the residual air 16 remaining in the solder paste 14 filled in the through hole 10. A bump forming method according to the present embodiment is realized by using the solder paste printing method according to the present embodiment.

Details will be described below.

As shown in FIGS. 1A and 1B, the substrate 11 having a surface on which the electrode 12 is formed is prepared. Subsequently, the metal mask 13 is arranged on the substrate 11 to locate the through hole 10 of the metal mask 13 having the through hole 10 on the electrode 12, and the gap portion 13a communicating with the through hole 10 is formed in the interface between the substrate 11 and the metal mask 13.

As shown in FIGS. 2A and 2B, the solder paste 14 is moved from an upper surface of the metal mask 13 by using a squeegee 15 in the direction indicated by an arrow 17 (printing direction), so that the solder paste 14 containing a flux is filled in the through hole 10.

At this time, the solder paste 14 is filled in the through hole 10 in the direction opposite to the direction of the arrow 17 (printing direction). For this reason, air in the through hole 10 is moved by the filled solder paste 14 in the direction indicated by an arrow 18 and pushed into the gap portion 13a communicating with the through hole 10 formed in the interface between the substrate 11 and the metal mask 13. Furthermore, since a pressure acts on the inside of the through hole 10 due to a pressure generated in printing, a flux contained in the solder paste 14 oozes out of the solder paste 14 and is pushed from the through hole 10 into the gap portion 13a. In this manner, the residual air 16 in the solder paste 14 is pushed into the gap portion 13a without clogging the deaeration path for the residual air 16.

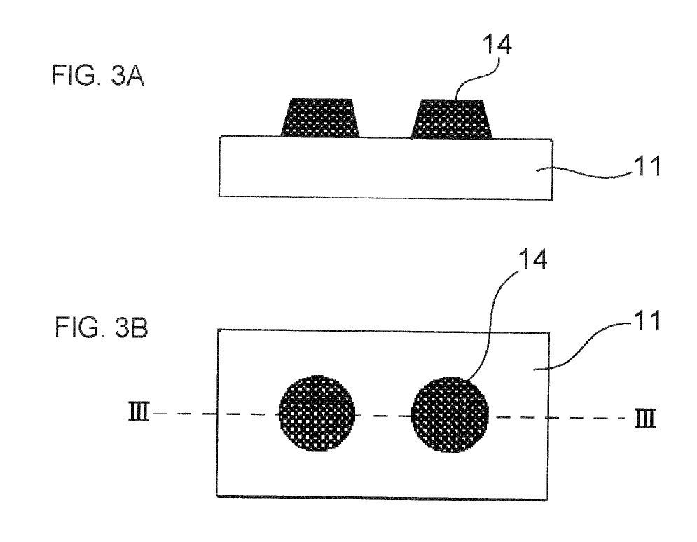

As shown in FIGS. 3A and 3B, the metal mask 13 is separated from the substrate 11 on which the solder paste 14 is printed. In this manner, the solder paste 14 can be printed on the substrate 11.

Subsequently, by using the solder paste printing method according to the present embodiment, as shown in FIGS. 4A and 4B, the solder paste 14 is heated and melted to form the bump 19.

An effect of the present embodiment will be described below.

The solder paste printing method includes the step of arranging the metal mask 13 on the substrate 11 to locate the through hole 10 of the metal mask 13 having the through hole 10 on the electrode 12 and forming the gap portion 13a communicating with the through hole 10 in the interface between the substrate 11 and the metal mask 13. In the step of filling the solder paste 14, the flux is guided to the gap portion 13a together with the air in the through hole 10.

In the metal mask 13 used in the method for printing a metal paste which fills the solder paste 14 in the through hole 10 and prints the solder paste 14 on the substrate 11, at least one surface of the metal mask 13 has a recessed portion which forms the gap portion 13a communicating with the through hole 10 between the metal mask 13 and the substrate 11. The gap portion 13a is configured to guide the flux together with the air in the through hole 10.

According to the solder paste printing method and the metal mask 13 having the above configurations, in filling of the solder paste 14, the flux oozing on the surface of the solder paste 14 can be moved to the gap portion 13a. In other words, the deaeration path for the residual air 16 in the solder paste 14 clogged with the flux is secured by removing the flux. In this manner, air remaining in the solder paste 14 in the through hole 10 can be removed, and a filling rate of the solder paste 14 can be increased. Air which is present in the through hole 10 in filling of the solder paste 14 can also be moved to the gap portion 13a by the filled solder paste 14.

By using the solder paste printing method described above, a bump forming method which is suitable for formation of a bump having high connection reliability and good outer dimension accuracy is realized.

Japanese Laid-open patent publication NO. 2000-062136 discloses that, when a solder paste is filled on an electrode formed on a bottom of a recessed portion, an opening size of the metal mask is made smaller than an opening size of the recessed portion to secure an interval between the metal mask and the substrate. It is described that in this manner air in filling of the solder paste can be pushed out from a gap above a portion near an edge of the recessed portion. However, in order to form a deaeration path for air, a mask having a small opening size is disadvantageously further required above the opening of the through hole. In contrast to this, in the present embodiment, since the metal mask 13 having the recessed portion 113 communicating with the through hole 10 is used, a deaeration path for air is secured in the interface between the metal mask 13 and the substrate 11. In the present embodiment, deaeration is not performed from an upper side of the through hole 10, and the gap portion 13a communicating with the through hole 10 is formed between the metal mask 13 and the substrate 11 to secure a deaeration path above the through hole 10. For this reason, even when a pressure acts from the upper side in printing, the deaeration path can be secured.

Since the solder paste printing method is not limited to a specific method, a filling rate of a metal can be improved without increasing the number of steps of forming a bump. Design of an apparatus for forming a bump is not required to be changed.

### Second Embodiment

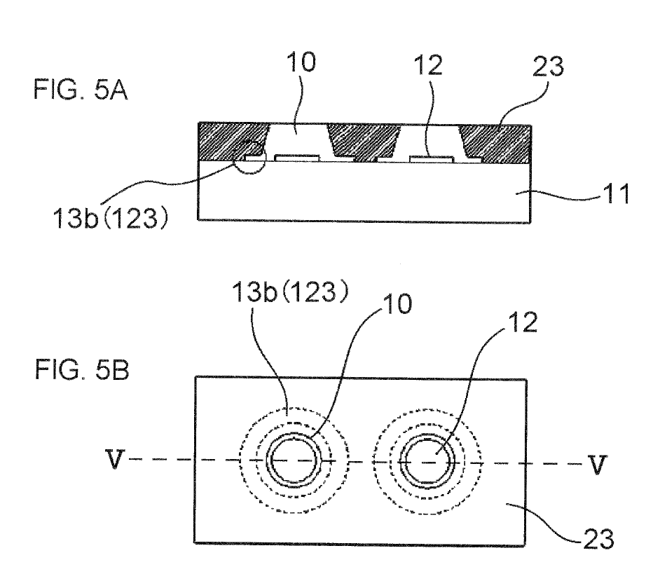

FIG. 5A is a sectional view showing a second embodiment of a metal mask according to the present invention. In the first embodiment, the gap portion 13a is formed to cause the through holes 10 to communicate with each other. In the present embodiment, the through holes 10 do not communicate with each other.

As shown in FIG. 5A, gap portions 13b are formed for two through holes 10, respectively, and do not communicate with each other. More specifically, the through holes 10 do not communicate with each other. As shown in FIG. 5B, on a lower surface of a metal mask 23, the through hole 10 and a recessed portion 123 (step) extending throughout the circumference of an opening of the through hole 10 are formed. By the recessed portion 123, the gap portion 13b is formed in an interface between the substrate 11 and the metal mask 23.

The solder paste printing method using the metal mask 23 with the above configuration can be performed by the same manner as described in the first embodiment. The bump 19 using the metal mask 23 with the configuration can be formed in the same manner as in the case in which the metal mask 13 is used.

In the present embodiment, the gap portion 13b (recessed portion 123) does not communicate with the gap portion 13b formed to communicate with another through hole 10. For this reason, movement of the flux generated from one through hole 10 can be limited to the inside of the gap portion 13b. Another effect of the present embodiment is the same as that of the above-described embodiment.

### Third Embodiment

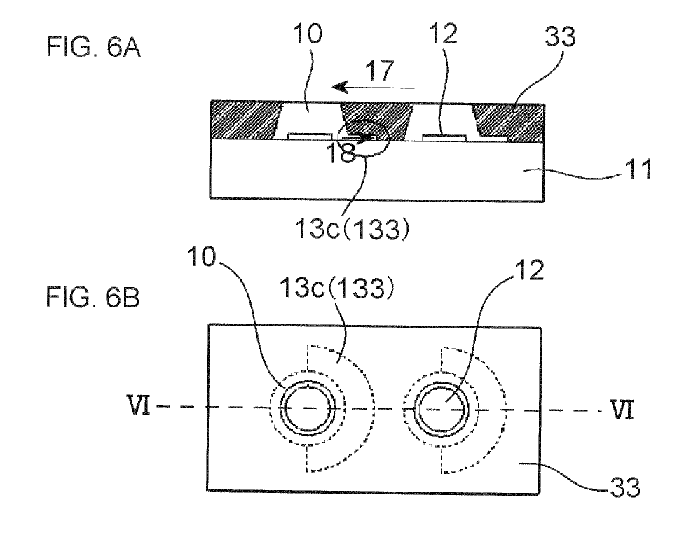

FIGS. 6A and 6B are cross-sectional view and plan view showing a third embodiment of a metal mask according to the present invention. In the second embodiment, the gap portion 13b is formed throughout the circumference of the opening of the through hole 10. In the present embodiment, the gap portion 13c is formed in a part of the circumference of the opening of the through hole 10.

As shown in FIG. 6A, the gap portion 13c is formed in a part of the circumference of the opening of the through hole 10. As shown in FIG. 6B, the through hole 10 and the recessed portion 133 (step) in a part of the circumference of the opening of the through hole 10 are formed on a lower surface of a metal mask 33. More specifically, the gap portion 13c is formed in a part of the circumference of the through hole 10 on a side (direction indicated an arrow 18) opposite to the arrow 17 indicating a printing direction. The gap portion 13c only has to be a part of the circumference of the through hole 10, or ¼, a half, or ¾ of the circumference. By the recessed portion 133, the gap portion 13c is formed in the interface between the substrate 11 and the metal mask 33.

The solder paste printing method using the metal mask 33 with the above configuration can be performed by the same manner as that described in the first embodiment. The bump 19 using the metal mask 33 with the above configuration can be formed in the same manner as that in the case in which the metal mask 13 is used.

In the present embodiment, the gap portion 13c is formed in a part of the circumference of the through hole 10 on a side opposite to the printing direction. For this reason, moving directions of the flux and the air can be specified by a forming position of the gap portion 13c (recessed portion 133). Other effects of the present embodiments are the same as those in the above-described embodiments.

The solder paste printing method and the metal mask according to the present invention are not limited to the above-described embodiments, and can be variously modified.

For example, in the above-described embodiments, in a cross-sectional view, the gap portion 13a extends in a horizontal direction. However, the gap portion 13a may be formed in a vertical direction. In this case, the gap portion 13a is preferably a longitudinally long slit shape, and a slit width is preferably smaller than a solder particle diameter.

For example, in the descriptions of the above-described embodiments, the gap portion 13a communicating with the through hole 10 is formed between the substrate 11 and the metal mask 13 as a recessed portion formed in the lower surface of the metal mask 13. A gap portion may be formed by forming a projecting portion on the lower surface of the metal mask 13. In this case, a portion on which the projecting portion is not formed corresponds to the gap portion 13a.

In the descriptions of the above-described embodiments, the printing method uses a solder paste. However, the paste is not limited to the solder. The number of the through holes 10, arrangement positions of the through holes 10, and the shapes of the through holes 10 are not limited to specific ones. The shapes of the gap portions 13a, 13b, and 13c are riot limited to the shapes described above.

It is apparent that the present invention is not limited to the above-described embodiment, and may be modified and changed without departing from the scope and spirit of the invention.

What is claimed is:

1. A method for printing a metal paste comprising:
preparing a substrate having a surface on which an electrode is formed;
arranging, to locate a through hole of a metal mask having said through hole on said electrode, said metal mask on said substrate and forming a gap portion communicating with said through hole in an interface between said substrate and said metal mask; and
filling a metal paste containing a flux in said through hole, wherein
said gap portion is formed by an upper surface of said substrate and a recessed portion formed in a lower surface of said metal mask, and,
in said filling a metal paste, said flux is guided to said gap portion together with air in said through hole.

2. The method for printing a metal paste according to claim 1, wherein
said metal paste contains solder particles, and
the height of said gap portion is smaller than the diameter of said solder particle.

3. The method for printing a metal paste according to claim 1, wherein said gap portion is formed to cause said plurality of through holes to communicate with each other.

4. The method for printing a metal paste according to claim 1, wherein said gap portion is formed throughout a circumference of an opening of said through hole.

5. The method for printing a metal paste according to claim 1, wherein said gap portion is formed in a part of a circumference of an opening of said through hole.

6. The method for printing a metal paste according to claim 1, wherein said gap portion is formed in a half circumference of said opening of said through hole.

7. A metal mask used in a metal paste printing method which fills a metal paste containing a flux in a through hole of a metal mask arranged on an object to be printed, wherein
at least one surface of said metal mask has a recessed portion which forms a gap portion communicating with said through hole in an interface between said metal mask and said object to be printed, and
said gap portion is configured to guide said flux 10 together with air in said through hole.

8. The metal mask according to claim 7, wherein
said metal paste includes solder particles, and
the height of said gap portion is smaller than diameters of said solder particles.

9. The metal mask according to claim 7, wherein said gap portion is formed to cause said plurality of through holes to communicate with each other.

10. The metal mask according to claim 7, wherein said gap portion is formed throughout a circumference of an opening of said through hole.

11. The metal mask according to claim 7, wherein said gap portion formed in a part of a circumference of an opening of said through hole.

12. The metal mask according to claim 7, wherein said gap portion is formed in a half circumference of an opening of said through hole.

13. A bump forming method which forms a hump by using the method for printing a metal paste according to claim 1.
